(19) United States
(12) Patent Application Publication
(10) Pub. No.: US 2002/0089512 A1
(43) Pub. Date: Jul. 11, 2002

(54) Reduced texture bandwidth method for providing filtering between texture mipmap levels

(76) Inventors: Paul Slade, San Jose, CA (US); Gary Tarolli, Concord, MA (US); Ryan Nunn, Newton (AU)

Correspondence Address: OPPENHEIMER WOLFF & DONNELLY, P. O. BOX 10356, PALO ALTO, CA, 94303, US

(21) Appl. No.: 09/997,193

(22) Filed: Nov. 28, 2001

Related U.S. Application Data
(60) Provisional application No. 60/253,957, filed on Nov. 28, 2000.

(51) Int. Cl. G09G 5/00

(52) U.S. Cl. 345/582

(57) ABSTRACT

A method for multiple rendering of an image includes selecting a level of detail (LOD) and selecting a set of offset biases based on the number of renderings. The offset biases are combined with the LOD resulting in processing biases. The processing biases are then truncated. The truncated bias values are then used as the basis of mipmap level processing for each rendering. The resulting renderings are then accumulated and sent to an output video device or additional image processor. Also, a computer system for carrying out the process may include multiple graphics processors containing registers, so that the offset biases can be rotated for each rendering between processors.

### CROSS REFERENCE TO RELATED APPLICATIONS

This application claims priority from provisional application U.S. Serial No. 60/253,957 (Atty. Docket No. 60412-301000), filed on Nov. 28, 2000, entitled “A Reduced Texture Bandwidth Method for Providing Filtering Between Texture Mipmap Levels”, incorporated herein by reference.

### BACKGROUND OF THE INVENTION

This invention relates generally to computer image generation, and more particularly to texture filtering.

Recent advances in computer performance have enabled graphic systems to provide more realistic graphical images using personal computers and home video game computers. In such graphic systems, some procedure must be implemented to “render” or draw graphic primitives to the screen of the system. A “graphic primitive” is a basic component of a graphic picture, such as a vector, or a polygon, e.g., a triangle. All graphic pictures are formed with combinations of these graphic primitives. Any of many procedures may be utilized to perform graphic primitive rendering.

Conventional graphic systems perform these graphic rendering procedures using a frame buffer. A frame buffer generally includes computer memory chips that store information concerning pixel activation on the system's display screen. Generally, the frame buffer includes all of the graphic information that will be written onto the screen.

Early graphic systems displayed images representing objects having extremely smooth surfaces. That is, textures, bumps, scratches, or other surface features were not modeled. In order to improve the quality of the image, texture mapping was developed to model the complexity of real world surface images. In general, texture mapping is the mapping of an image or a function onto a surface in three dimensions. Texture mapping is a relatively efficient technique for creating the appearance of a complex image without the tedium and the high computational cost of rendering the actual three dimensional detail that might be found on a surface of an object.

Many parameters have been texture mapped in conventional systems. Some of these parameters include surface color, specular reflection, normal vector perturbation, specularity, transparency, diffuse reflections, and shadows. In texture mapping, a source image known as the “texture” is mapped onto a surface in three dimensional space. The three dimensional surface is then mapped to the destination image. The destination image is then displayed on a graphic display screen. Examples of the texture of an object include the gravel on a highway or scuff marks on a wooden surface.

A texture map is made up of texture elements, i.e., “texels”. Occasionally, in a rendering of an object using a texture map, one texel will correspond directly to a single pixel that is displayed on a monitor. In this situation the level of detail (LOD) is defined to be equal to zero (0) and the texel is neither magnified nor minified. However, the displayed image can be a magnified or minified representation of the object. If the object is magnified, multiple pixels will represent a single texel. A magnified object corresponds to a negative LOD value. If the object is minified, a single pixel represents multiple texels. A minified object corresponds to a positive LOD value. In general, the LOD value corresponds to the ratio of the texel pitch to the pixel pitch. When the object is minified, aliasing can occur in the displayed image because a single pixel represents multiple texels. Aliasing occurs because display screens comprise a finite number of pixels. For example, if a number of texels represent a smooth boundary between two different objects having significantly different colors, and each pixel represents more than one texel, the boundary can appear jagged or discontinuous due to differences in the elevation of horizontally contiguous pixels or differences in the position of vertically contiguous pixels. Texture filtering techniques can be used to reduce this aliasing effect.

A simple form of texture filtering is a “point sampling” filtering technique. When using the point sampling filtering technique, each pixel value is set equal to the value of the texel that is the closest to the pixel center. However, this technique does not reduce texture aliasing.

Other texture filtering techniques determine the texels that overlap each pixel and then compute a weighted average of these texels. Such filtering techniques are more accurate than the simple form of texture filtering described above; i.e., the texture aliasing effect is reduced. However, these other texture filtering techniques are more expensive in terms of memory accesses. More memory access require either more memory cycles, thereby reducing performance, or more memory pins, thereby increasing hardware costs.

Some texture filtering techniques reduce memory accesses by pre-computing filtered versions of the texture map and storing these pre-computed versions in memory. These pre-filtered versions of the texture map are called “mipmaps”. One technique for computing a set of mipmaps is to average each 2×2 block of texels in a texture map into one aggregate texel. This produces a mipmap twice as small in each dimension. This process is repeated until a 1×1 mipmap is produced. For example, a level 1 mipmap is a mipmap where each aggregate texel is the average of a 2×2 block of texels, a level 2 mipmap is a mipmap where each aggregate texel is the average of a 4×4 block of texels. A level “n” mipmap is a mipmap where each aggregate texel is the average of a 2ⁿ×2ⁿ block of texels.

Each mipmap level corresponds to a LOD value. For example, a level 1 mipmap corresponds to a LOD value of one, a level “n” mipmap corresponds to a LOD value of “n”. If the LOD value is equal to an integer, e.g., 2, then the ratio of pixels to mipmap level 2 aggregate texels is 1:1. In this situation, the pixel values will be determined based upon aggregate texel values in the level 2 mipmap. Frequently, however, the LOD value is not equal to a mipmap level, i.e., the LOD value includes both an integer component and a non-zero fractional component. When the LOD value includes a non-zero fractional component, some texture filtering techniques include a procedure for determining the pixel value based upon the associated aggregate texel values located in the two nearest mipmaps, i.e., a lower level mipmap and a higher level mipmap.

A simple texture filtering technique that utilizes mipmaps equates each pixel value with the associated aggregate texel value in the mipmap that is most closely associated with the LOD value. For example, if the LOD value is equal to 2.25, each pixel will be set equal to the value of an associated aggregate texel in the level 2 mipmap. Similarly, if the LOD value is equal to 2.75, each pixel will be set equal to the value of an associated aggregate texel in the level 3 mipmap. One technique for determining the aggregate texel that is associated with a pixel is to select the aggregate texel whose center is the closest to the pixel center. Although this method is inexpensive to implement, only a moderate image quality is achieved because the LOD value is rounded to the nearest integer for all pixels and all pixel values are determined based upon the value of a single texel from the nearest mipmap level.

A higher image quality is achieved using a bilinear filtering technique. In bilinear filtering, a weighted average of four texels values (from a single mipmap level) that surround the pixel center is computed. By way of illustration, FIG. 1 is a diagram of a 16 texel by 16 texel portion of a destination image 100. In this example, the LOD value is 1.585. As described in greater detail below, the number of texels per pixel is equal to 2^{1.585}=3.00. The area represented by each pixel 120 is illustrated in FIG. 1 as a 3 texel by 3 texel block. Because the integer “2” is the closest integer to the LOD value, a level 2 mipmap is selected, and the texel values from the level 2 mipmap are used to determine the pixel values. Each aggregate texel 110 in the level 2 mipmap is the average of a 4×4 block of texels and is illustrated in FIG. 1 by a dashed line. FIG. 1 illustrates the relative position of texels and pixels when all texels represent a shape at a constant distance from a viewer. If the pixels of a shape are rendered using texels, and the shape represents an object that is at different distances from the viewer, e.g., a road that begins at the viewer and continues to the horizon, then the shape of the pixel will vary based upon this variation in distance and upon the viewing angle. When determining the value of a pixel, e.g., 120, using bilinear filtering, the values of the four aggregate texels that are the closest to the center of the pixel 120 are weighted based upon the distance from the center of each aggregate texel to the pixel center 120. The bilinear filtering technique utilized in the present invention is described below. Bilinear filtering is more accurate than the first technique described above and requires only four memory accesses if four texels are used to determine the pixel value. However, when using bilinear filtering the value of each pixel 120 that has the same LOD value is still based upon the aggregate texel values from a single mipmap level.

Trilinear filtering is a technique addressing the limitations of bilinear filtering. If the LOD value has a non-zero fractional portion, bilinear filtering is performed for both the lower level mipmap and the higher level mipmap. The pixel value is determined by calculating a weighted average of the two resulting values, i.e., one value for each mipmap level. The weight of each result is based upon the fractional portion of the LOD value. For example, if the LOD value is 1.585, a bilinear filtering technique will be performed for each pixel using both the level 1 mipmap and the level 2 mipmap. For each pixel, the value determined using the bilinear filtering technique with the level 1 mipmap will be combined with the value determined using the bilinear filtering technique using the level 2 mipmap. The weight of each of these two values is based upon the fractional portion of the LOD value, e.g., 0.585. Trilinear filtering is an accurate technique for determining pixel values. However, trilinear filtering requires eight memory accesses, i.e., four memory accesses for reading the four closest aggregate texel values in the lower level mipmap and four memory accesses for reading the four closest aggregate texel values in the higher level mipmap. These additional memory accesses, as compared to bilinear filtering, are undesirable.

Accordingly, what is needed is a texture filtering technique that determines pixel values more accurately than bilinear filtering, while not requiring the additional memory access expense of trilinear filtering.

### SUMMARY OF THE INVENTION

This invention provides an improved method for texture filtering technique that determines pixel values more accurately than bilinear filtering, while not requiring the additional memory access expense of trilinear filtering. According to the invention, the number of memory accesses is reduced by determining a pixel value based upon one or more texel values, for example four texel values, from one mipmap level selected based upon the integer portion of the biased LOD value.

In one general aspect the invention features a method and apparatus for multiple rendering of an image, by: selecting a level of detail (LOD), selecting a set of offset biases based on the number of renderings, applying the offset biases to the LOD to obtain processing biases, truncating the processing biases, rendering the image using the truncated bias values as the basis for mipmap level processing, accumulating the resulting renderings to obtain a final rendering, and sending the final rendering to the output video device or image processor.

In particular embodiments the number of offset biases is equal to the number of required renderings, and in some embodiments the offset biases are determined by the formula: 0/N, 1/N, 2/N, . . . (N−)/N, where N is the total number of required renderings.

In another general aspect the invention features a computer system configured to carry out the texture filtering method. In some embodiments multiple graphics processors containing registers are employed in carrying out the method, so that the offset biases can be rotated for each rendering between processors.

The present invention also includes a method and apparatus for reducing graphics processing time that includes assigning a set of index values to a set of registers, associating a set of level of detail (LOD) values to the index values, processing a set of polygons through the set of registers simultaneously, rotating the index values relative to the set of registers wherein said set of LOD values are also rotated and processing said set of polygons through said set of registers simultaneously. The entire set of polygons is processed through every LOD value of the LOD set. A next set of polygons can then be processed if the previous set has finished processing.

The method and apparatus can also include rotating the index values after a plurality of polygons has been processed.

The present invention requires each primitive to be rendered using simple bilinear filtering. Since many systems can render at up to twice the speed when performing simple bilinear filtering as opposed to full trilinear filtering, the present invention allows for full trilinear filtering while only performing a simple bilinear filtering.

Additionally, some systems are capable of rendering using multiple textures simultaneously, these textures being blended in some way to provide the color to be used. Such systems often have a restriction when using this multi-texturing technique that the textures may be at best bilinear mipmap filtered. Using the method of the present invention allows for all textures being used in a system with this restriction to be rendered with trilinear filtering.

These and other advantages of the present invention will become apparent upon a reading of the following descriptions and a study of the various figures of the drawings.

### BRIEF DESCRIPTION OF THE DRAWINGS

The present invention will be readily understood by the following detailed description in conjunction with the accompanying drawings, with like reference numerals designating like elements.

FIG. 1 is a prior art diagram of a 16 texel by 16 texel portion of a destination image.

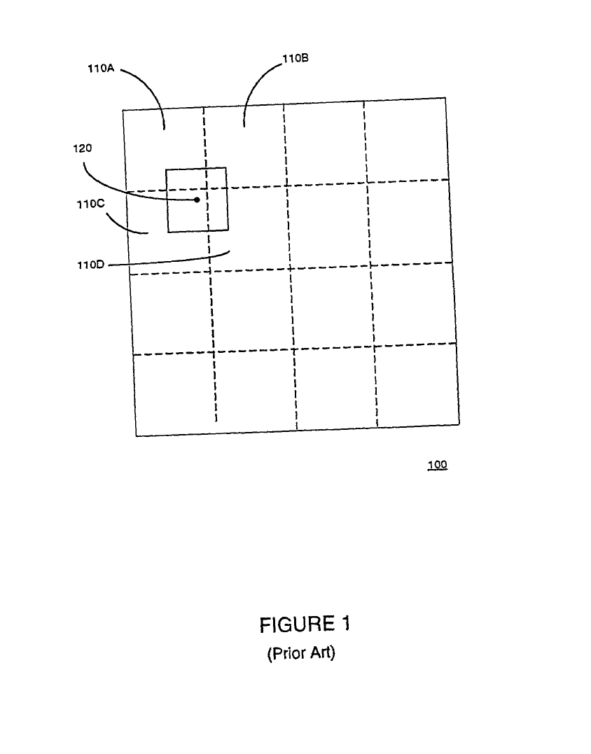

FIG. 2 is an example of a computer system that includes a graphics processor and a display device.

FIG. 3 is illustrates the equivalent LOD values for a range of input LOD values.

FIG. 4 illustrates a method for reducing graphics processing time.

FIG. 5 illustrates a method for multiple rendering of an image.

FIG. 6 illustrates a method for reducing graphics processing time.

### DETAILED DESCRIPTION OF THE PREFERRED EMODIMENT(S)

The invention will now be described in detail.

The method of this invention can be implemented upon a computer graphics image generator that meets the following requirements:

1) It is capable of point sample or bilinear mipmap filtered texturing;

2) It is capable of calculating the LOD value used for mipmap selection to a fractional precision;

3) It provides for allowing the LOD value to be biased by a fractional amount prior to being used for mipmap selection, and it is capable of setting the bias amount differently for the same primitive/polygon rendered to each of the frame buffers to be accumulated; and

4) The system is capable of rendering the image multiple times and accumulating the result prior to being sent to the video output. Any of a variety of methods of this accumulation may be employed, such as for example, current systems that either accumulate the buffers into a final buffer which is output after the accumulation is complete, or perform the accumulation directly as the data from the frame buffers are output to the video sub-system.

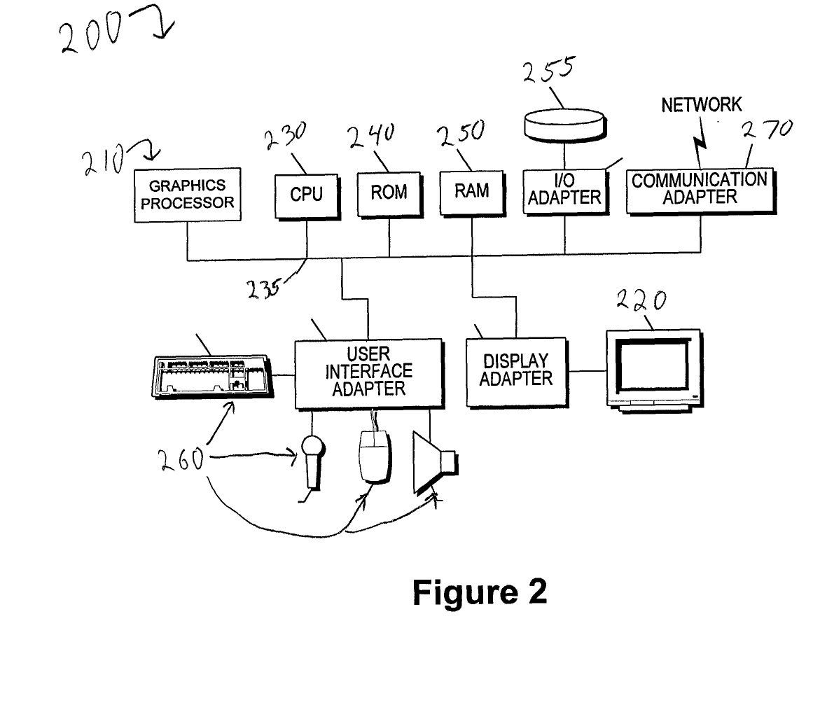

FIG. 2 is an example of a computer system 200 that includes a graphics processor 210 and a display device 220. Also typically included is a central processing unit (CPU) 230, a data bus 235, a read only memory (ROM) 240, a random access memory (RAM) 250a storage device 255 and various user interface devices (keyboard, microphone, mouse, etc) 260. Optionally, the system can also include a communications means 270 that can connect to a network, for example, the Internet.

Many high quality image generators currently implement multiple renderings of the scene in order to achieve full scene antialiasing. This method of antialiasing is described, for example, in J. Neider, T. Davies and M. Woo, “OpenGL Programming Guide”, published by Addison-Wesley, ISBN 0-201-63274-9, in the section titled ‘Scene Antialiasing’ incorporated herein by reference. The method of this invention may be used along side such a method of full scene antialiasing, with little or no overhead.

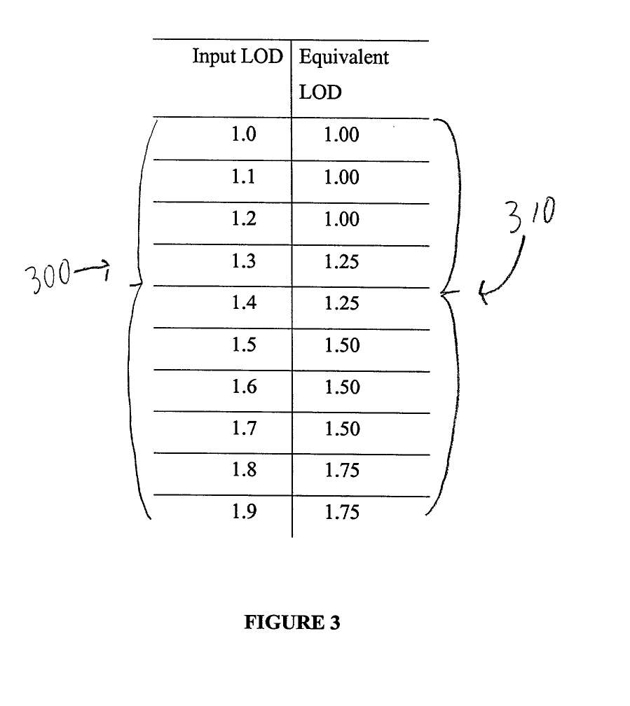

For the highest quality, the bias applied to the LOD for rendering each primitive should take on each of the values 0/N, 1N, 2/N, . . . (N−1)/N, where N is the total number of frame buffers being accumulated. According to the particular architecture and bottlenecks of the system in use, it may be preferred to use different algorithms for the selection of which bias to use for each primitive rendered in each of the frame buffers. As long as each primitive takes on each of the desired values in at least one of the frame buffers then the required result will be obtained. To further illustrate, take for example a primitive that is rendered four times to produce a final image. The bias values used would be 0, 0.25, 0.50 and 0.75. If the hardware selects an LOD value of 1.3 to render a primitive, a level 1 mipmap is used based on rounding up or down to the nearest integer. As previously stated, the LOD value corresponds to the required mipmap level. The graphic processors then will add the offsets to obtain 1.3, 1.55, 1.8 and 2.05. Bilinear filtering is then applied to each frame, that is, each frame is processed by truncating the offset values to produce new mipmap levels: 1, 1, 1 and 2. The resulting processed frames are then accumulated together to render the final image. The resulting pixel will be equivalent to 0.75 times the color generated from mipmap level one, plus 0.25 times the color generated from mipmap level two. This is equivalent to the result that would have been obtained using traditional trilinear filtering with an LOD value of 1.25. FIG. 3 illustrates the equivalent LOD values 300 for a range of input LOD values 310.

From FIG. 3 it can be seen that the fractional part of the LOD value is effectively being quantized to a number of levels equivalent to the number of renderings of the scene. Briefly, in one general aspect the invention features a method and apparatus for multiple rendering of an image, by: selecting a level of detail (LOD), selecting a set of offset biases based on the number of renderings, applying the offset biases to the LOD to obtain processing biases, truncating the processing biases, rendering the image using the truncated bias values as the basis for mipmap level processing, accumulating the resulting renderings to obtain a final rendering, and sending the final rendering to the output video device or image processor.

In particular embodiments the number of offset biases is equal to the number of required renderings, and in some embodiments the offset biases are determined by the formula: 0/N, 1N, 2/N, . . . (N−1)/N, where N is the total number of required renderings.

In another general aspect the invention features a computer system configured to carry out the texture filtering method. In some embodiments multiple graphics processors containing registers are employed in carrying out the method, so that the offset biases can be rotated for each rendering between processors.

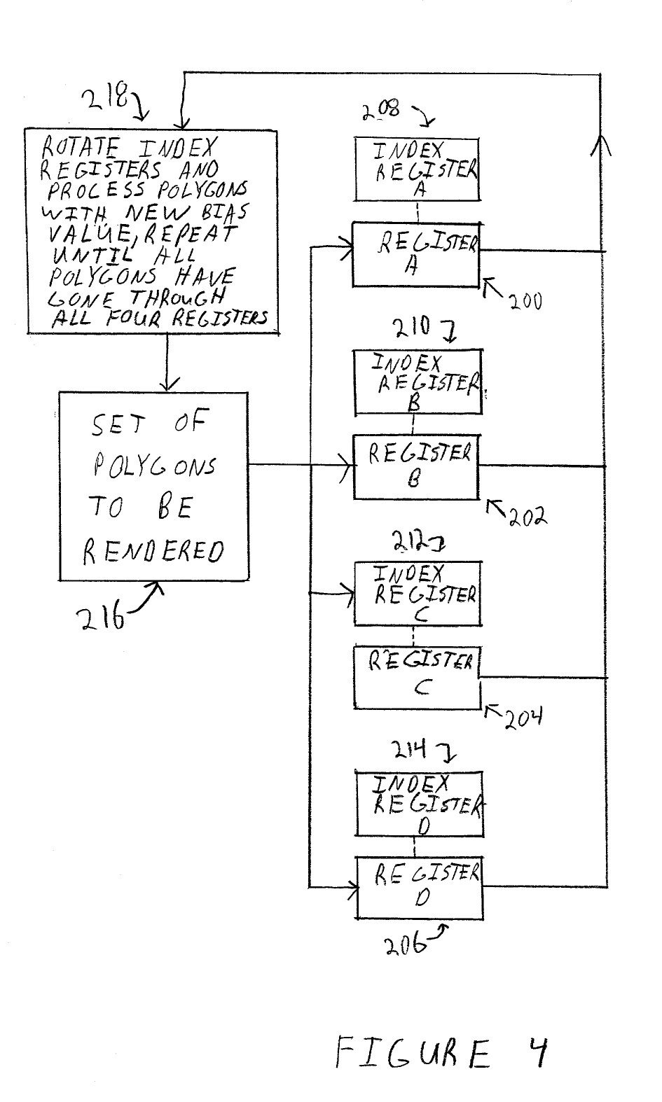

In modem graphic processing systems, the factor limiting how fast the entire system can run is the memory access time, and not the processing speed of the computer chips. In the example described above, the processors dealing with the higher mipmap levels take less processing time than with lower mipmap levels because the higher mipmap levels correspond to a higher LOD and thus a more “fuzzy” image. The higher mipmap level requires fewer accesses to texture memory and, as a result, finish being processed sooner than lower mipmap levels. To render the final pixel however, all four processors must complete their respective tasks. In order to avoid the situation of a graphic processor sitting idle while other processors are finishing their jobs, a method can be implemented to rotate the bias values across the channels on a per primitive, or every few primitives basis. This results in a reduction of the total processing time for an image. FIG. 4 illustrates this method for reducing graphics processing time. On each of the pieces of hardware (for example in the graphics processor 210 of FIG. 2), there are a set of registers; in the example of an image rendered four times, there are four registers (register A 200, register B 202, register 204 and register D 206). The software puts into each of those four registers the bias that the hardware requires. The software also initializes index registers corresponding to each of the bias values (index register A 208, index register B 210, index register 212 and index register D 214). The first channel index will contain 0, the second will contain 1, the third will contain 2 and the fourth will contain 3. As the rendering progresses, a polygon is sent to the hardware (for example from the set of polygons to be rendered 216). The hardware increments its index values and uses the bias that is in the register that has been indexed. For the first polygon, the bias would be 0.25. For the second polygon the index is incremented to 2 and a bias value of 0.5 is used. The next polygon has an index of 3 and a bias of 0.75. For the next polygon, the index and bias go back to 0. All of the pieces of hardware are being sent the same sets of polygons. Because each index register is set to a different value in each of the four sets of registers, they will be out of step in terms of what bias value is being applied to each received polygon. The first received polygon goes to channel 0, index 0, bias 0; the second polygon goes to channel 1, index 1, bias 0.25; and so on. In short, they rotate (for example via rotating index function 218). The index value is incremented for every received polygon. When several thousand polygons are being rendered per frame, each bias used for each polygon is rotated. Thus the overall processing time is averaged out over the course of a frame.

By virtue of the fact that the index values are set differently by the software initially for each of the four sets of hardware, it is ensured that every polygon that is rendered is processed using all four different values on the four sets of hardware. If a frame needs 8 renderings, 8 registers would be required. There is a set of registers in each piece of hardware.

Algorithms for selecting the distribution of the biases among the frame buffers include, but are not limited to:

1) Applying the same bias to all primitives in a buffer. This method is suitable for systems that render each buffer in its entirety before rendering the subsequent buffer.

2) Rotating the bias applied to each buffer after each several primitives are rendered. Again, this method is suitable for systems that render each of the buffers in parallel using separate rendering pipelines. It may be used instead of 1) on systems where there is some overhead in rotating the LOD bias values, for example if software must write to one or more registers. The number of polygons rendered before each rotation would depend upon the balance between the overhead of performing the rotation and the overall rendering speed up provided by the rotation.

On some systems it may not be possible to apply each of the desired bias values. For example, a system may represent the LOD bias value internally at a limited precision. If the precision is two bits of fraction, then only four different fractional values may be applied. This may provide an upper limit to the number of levels of blending produced. On such systems it can be desirable to use each available fractional bias level an equal number of times.

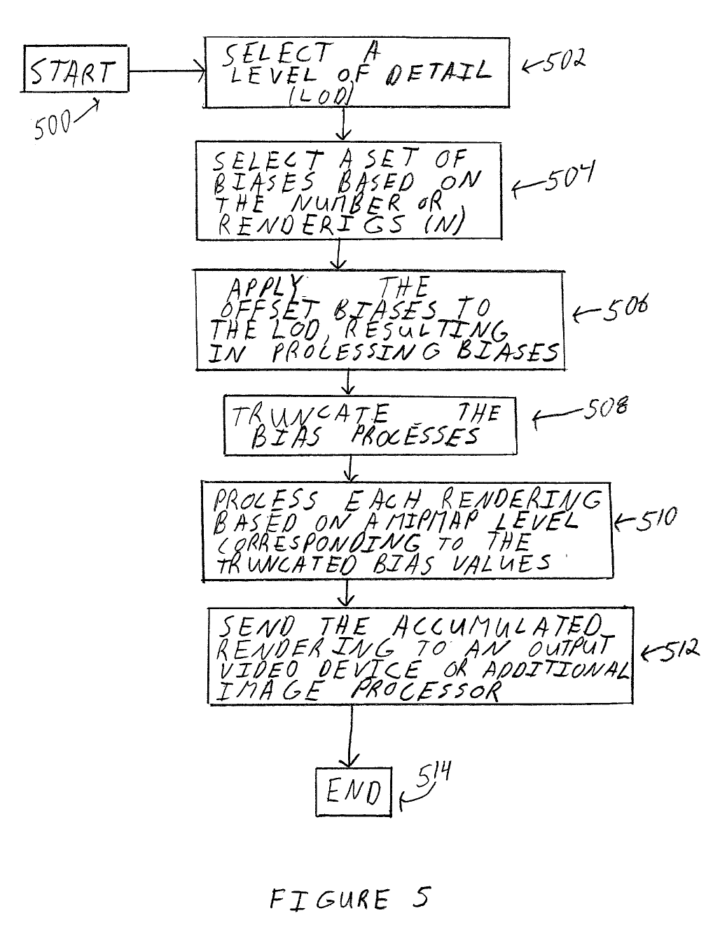

FIG. 5 illustrates a method for multiple rendering of an image. Beginning at Start 500, a level of detail (LOD) is selected via operation 502. A set of biases is then selected based on the number of renderings (N) at operation 504. In operation 506, the offset biases are applied to the LOD resulting in processing biases. The bias processes are then truncated at operation 508. Each rendering is then processed on a mipmap level corresponding to the truncated bias values in operation 510. The accumulated renderings are then sent to an output video device or additional image processor in operation 512. The method is then finished at operation 514.

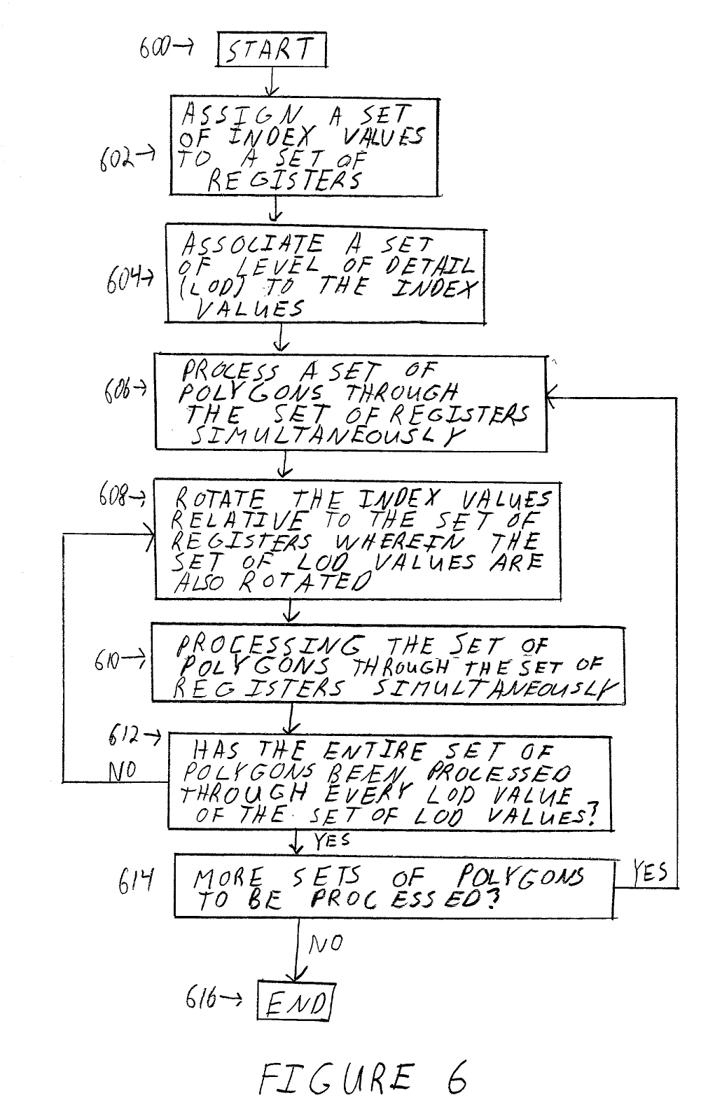

FIG. 6 illustrates a method for reducing graphics processing time. Beginning at Start operation 600, a set of index values is assigned to a set of registers at operation 602. A set of level of detail values (LOD) is associated to the index values at operation 604. In operation 606, a set of polygons is processed through the set of registers simultaneously. The index values are then rotated relative to the set of registers wherein the set of LOD values are also rotated, via operation 608. In operation 610, the set of polygons are processed through the set of registers simultaneously. Operation 612 checks to see if the entire set set of polygons has been processed through every LOD value of the set of LOD values. If no, control is passed back to operation 608. At operation 614, it is determined of more set of polygons needs to be processed. If yes, control is passed back to operation 606. If not, the method ends at operation 616.

Briefly, the present invention includes a method and apparatus for reducing graphics processing time that includes assigning a set of index values to a set of registers, associating a set of level of detail (LOD) values to the index values, processing a set of polygons through the set of registers simultaneously, rotating the index values relative to the set of registers wherein said set of LOD values are also rotated and processing said set of polygons through said set of registers simultaneously. The entire set of polygons is processed through every LOD value of the LOD set. A next set of polygons can then be processed if the previous set has finished processing.

The method and apparatus can also include rotating the index values after a plurality of polygons has been processed.

In addition to the reduced texture bandwidth requirement compared to traditional trilinear texturing there may be other advantages to this method on certain systems, such as:

1) Many systems can render at up to twice the speed when performing simple bilinear filtering as opposed to full trilinear filtering. Since this method requires each primitive to be rendered using simple bilinear filtering it may run at up to twice the speed when compared to using full trilinear.

2) Some systems are capable of rendering using multiple textures simultaneously, these textures being blended in some way to provide the color to be used. Such systems often have a restriction when using this multi-texturing technique that the textures may be at best bilinear mipmap filtered. Using the method of this invention allows for all textures being used in a system with this restriction to be rendered with trilinear filtering.

While various embodiments have been described above, it should be understood that they have been presented by way of example only, and not limitation. Thus, the breadth and scope of a preferred embodiment should not be limited by any of the above described exemplary embodiments, but in accordance with the true spirit and scope of the invention.

Other embodiments are within the following claims.

What is claimed is:

1. A method for multiple rendering of an image comprising:
selecting a level of detail (LOD);
selecting a set of offset biases based on the number of renderings (N);
applying said offset biases to said LOD resulting in processing biases;
truncating said processing biases;
processing each rendering based on a mipmap level corresponding to said truncated bias values;
accumulating the resulting renderings; and
sending said accumulated rendering to an output video device or additional image processor.

2. The method of claim 1 wherein the number of said offset biases is equal to said number of renderings (N).

3. The method of claim 2 wherein said offset biases are determined by the formula:
0/N, 1/N, 2/N, . . . (N−1)/N.

4. The method of claim 3 further comprising:
rotating said offset biases for each of said renderings among a plurality of graphics processors containing registers.

5. A method for reducing graphics processing time comprising:
(a) assigning a set of index values to a set of registers;
(b) associating a set of level of detail (LOD) values to said index values;
(c) processing a set of polygons through said set of registers simultaneously;
(d) rotating said index values relative to said set of registers wherein said set of LOD values are also rotated;
(e) processing said set of polygons through said set of registers simultaneously;
(f) repeating steps (d) to (e) until said set of polygons has been processed through every LOD value of said set of LOD values; and
(g) repeating steps (c) to (f) for a next set of polygons until all polygons for an image have been rendered.

6. The method of claim 5 wherein rotating said index values relative to said set of registers wherein said set of LOD values are also rotated is completed after a plurality of polygons has been processed.

7. A apparatus for multiple rendering of an image comprising:
selecting a level of detail (LOD);
selecting a set of offset biases based on the number of renderings (N);
applying said offset biases to said LOD resulting in processing biases;
truncating said processing biases;
processing each rendering based on a mipmap level corresponding to said truncated bias values;
accumulating the resulting renderings; and
sending said accumulated rendering to an output video device or additional image processor.

8. The apparatus of claim 7 wherein the number of said offset biases is equal to said number of renderings (N).

9. The apparatus of claim 8 wherein said offset biases are determined by the formula:
0/N, 1/N, 2/N, . . . (N−1)/N.

10. The apparatus of claim 9 further comprising:
rotating said offset biases for each of said renderings among a plurality of graphics processors containing registers.

11. An apparatus for reducing graphics processing time comprising:
(a) assigning a set of index values to a set of registers;
(b) associating a set of level of detail (LOD) values to said index values;
(c) processing a set of polygons through said set of registers simultaneously;
(d) rotating said index values relative to said set of registers wherein said set of LOD values are also rotated;
(e) processing said set of polygons through said set of registers simultaneously;
(f) repeating steps (d) to (e) until said set of polygons has been processed through every LOD value of said set of LOD values; and
(g) repeating steps (c) to (f) for a next set of polygons until all polygons for an image have been rendered.

12. The apparatus of claim 11 wherein rotating said index values relative to said set of registers wherein said set of LOD values are also rotated is completed after a plurality of polygons has been processed.
